(19) United States
(12) Patent Application Publication
(10) Pub. No.: US 2016/0318443 A1
(43) Pub. Date: Nov. 3, 2016

(54) CONTROLLING OSCILLATORY FEEDBACK PROVIDED THROUGH VEHICLE STEERING

(71) Applicant: Jaguar Land Rover Limited, Whitley Coventry Warwickshire (GB)

(72) Inventors: David Lickfold, Leamington Spa (GB); Nick Temple, Coventry (GB)

(21) Appl. No.: 14/702,371

(22) Filed: May 1, 2015

(51) Int. Cl. B60Q 9/00

(52) U.S. Cl. CPC B60Q 9/00

(57) ABSTRACT

A method for controlling the provision of oscillatory feedback through a steering system of a vehicle. The method comprises receiving a request to provide oscillatory feedback through the steering system of the vehicle. The method further comprises obtaining an electrical signal representative of a value of an applied steering torque that indicates the presence of a driver steering input, and comparing the value of the applied steering torque to a predetermined threshold value. The method still further comprises automatically inhibiting the provision of the oscillatory feedback when the applied steering torque value is above the predetermined threshold value.

### TECHNICAL FIELD

This invention relates to oscillatory feedback provided through vehicle steering and particularly, but not exclusively, to controlling the provision of oscillatory feedback through vehicle steering such that the provision of such feedback is automatically inhibited when certain criteria is met. Aspects of the invention relate to a method, to a non-transitory computer-readable storage medium, to a system, to an electronic controller, to a vehicle, to a vehicle steering system, and to an electric power assisted steering (EPAS) system.

### BACKGROUND

Various means are known in the art for providing feedback to drivers of motor vehicles about the state of the vehicle and/or its surroundings. For instance, feedback may be used to warn drivers when one or more particular defined conditions exist, such as, for example, when the vehicle is departing from the lane in which it is travelling or it is detected that a driver is drowsy.

This feedback may take any number of forms, one being oscillatory feedback. Oscillatory feedback, which may include, for example, haptic and/or audible feedback, has been found to be effective in providing warnings to drivers when certain defined conditions exist.

Oscillatory feedback may be delivered in a number of ways. One way is via a vehicle's steering input device, e.g., steering wheel. In particular, the steering wheel may be caused to vibrate to provide a warning to be sensed by the driver's hands. It is known to provide vibrations with dedicated vibration means, such as an electric motor and imbalance, within the steering wheel or within the steering column.

While providing oscillatory feedback certainly serves an important purpose of warning drivers when certain conditions exist, the provision of such feedback is not without its disadvantages. For example, providing oscillatory feedback in an instance wherein the driver is clearly controlling the vehicle may be undesirable.

Accordingly, it is an aim of the present invention to address, for example, the disadvantages identified above.

### SUMMARY OF THE INVENTION

According to one aspect of the invention for which protection is sought, there is provided a method for controlling the provision of oscillatory feedback through a steering system of a vehicle. In an embodiment, the method comprises: receiving a request to provide oscillatory feedback through the steering system of the vehicle; obtaining an electrical signal representative of a value of an applied steering torque that indicates the presence of a driver steering input; comparing the value of the applied steering torque to a predetermined threshold value; and when the applied steering torque value is above the predetermined threshold value, automatically inhibiting the provision of the oscillatory feedback.

According to another aspect of the invention for which protection is sought, there is provided a system for controlling the provision of oscillatory feedback through a steering system of a vehicle, comprising: an electronic processor having one or more electrical inputs for receiving a request to provide oscillatory feedback and for obtaining an electrical signal representative of a value of an applied steering torque that indicates the presence of a driver steering input; and an electronic memory device electrically coupled to the electronic processor and having instructions stored therein. In embodiment, the electronic processor is configured to access the memory device and execute the instructions stored therein such that it is configured to: receive a request to provide oscillatory feedback; obtain a value of an applied steering torque presented by an electrical signal received at the one or more electrical inputs of the electrical processor; compare the value of the applied steering torque to a predetermined threshold value; and when the applied steering torque value is above the predetermined threshold value, automatically inhibit the provision of oscillatory feedback.

According to a still further aspect of the invention for which protection is sought, there is provided an electronic controller for a vehicle having a storage medium associated therewith storing instructions therein that when executed by the controller causes the controlling of the provision of oscillatory feedback through a steering system of the vehicle in accordance with the method of: receiving a request to provide oscillatory feedback through the steering system of the vehicle; obtaining an electrical signal representative of a value of an applied steering torque that indicates the presence of a driver steering input; comparing the value of the applied steering torque to a predetermined threshold value; and when the applied steering torque value is above the predetermined threshold value, automatically inhibiting the provision of the oscillatory feedback.

According to yet another aspect of the invention for which protection is sought, there is provided a vehicle comprising the system or electronic controller described herein.

According to a further aspect of the invention for which protection is sought, there is provided a vehicle steering system comprising the system or electronic controller described herein.

According to a yet further aspect of the invention for which protection is sought, there is provided an electric power assisted steering system for a vehicle comprising the system or electronic controller described herein.

Accordingly to a yet still further aspect of the invention for which protection is sought, there is provided a non-transitory, computer-readable storage medium storing instructions thereon that when executed by one or more electronic processors causes the one or more electronic processors to carry out the method described herein.

Optional features of the various aspects of the invention are set out below in the dependent claims.

At least some embodiments of the present invention have the advantage that in instances wherein oscillatory feedback would ordinarily be provided due to the existence of one or more defined conditions, but it is determined that the driver is clearly controlling the vehicle, provision of the feedback is inhibited so as to not distract or disturb the driver while the driver is controlling the vehicle.

Within the scope of this application it is expressly intended that the various aspects, embodiments, examples, and alternatives set out in the preceding paragraphs, in the claims, and/or in the following description or drawings, and in particular the individual features thereof, may be taken independently or in any combination. That is, all embodiments and/or features of any embodiment can be combined in any way and/or combination, unless such features are incompatible. The applicant reserves the right to change any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, wherein like designations denote like elements, and in which:

FIG. 1 is a schematic side view of a vehicle comprising an illustrative embodiment of a vehicle steering system;

FIG. 2 is a schematic view of the vehicle steering system illustrated in FIG. 1;

FIG. 3 is a schematic view of an illustrative embodiment of a motor and rack and pinion coupling of the steering system illustrated in FIG. 2; and

FIG. 4 is a flow diagram depicting various steps of an illustrative embodiment of a method for controlling the provision of oscillatory feedback through a steering system of a vehicle.

### DETAILED DESCRIPTION

The systems and methods described herein may be used to automatically control the provision of oscillatory feedback through the steering system of a vehicle. In an embodiment, the systems and methods receive a request to provide oscillatory feedback through the steering system of the vehicle, obtain an electrical signal representative of a value of an applied steering torque that indicates the presence of a driver steering input, compare the value of the applied steering torque with a predetermined threshold value, and when the applied steering torque value is above the threshold value, automatically inhibit the provision of the oscillatory feedback.

References herein to a block such as a function block are to be understood to include reference to software code for performing the function or action specified in which an output is provided responsive to one or more inputs. The code may be in the form of a software routine or function called by a main computer program, or may be code forming part of a flow of code not being a separate routine or function. Reference to function blocks is made for ease of explanation of the manner of operation of a control system according to an embodiment of the present invention.

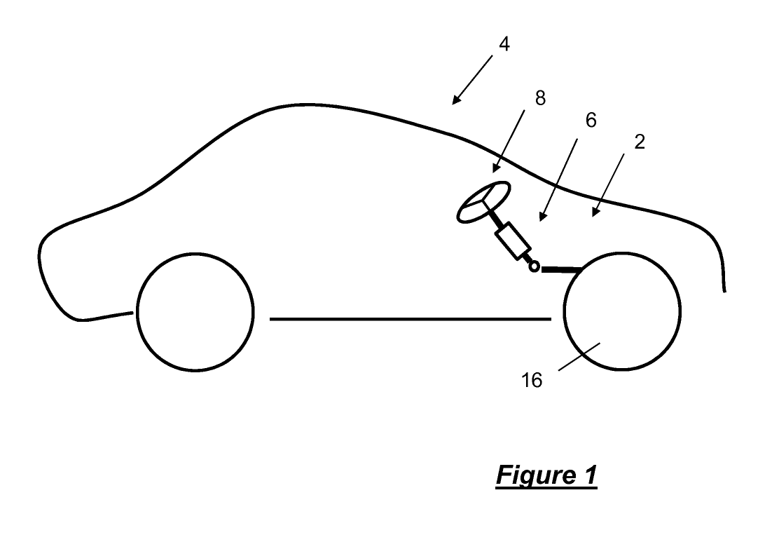

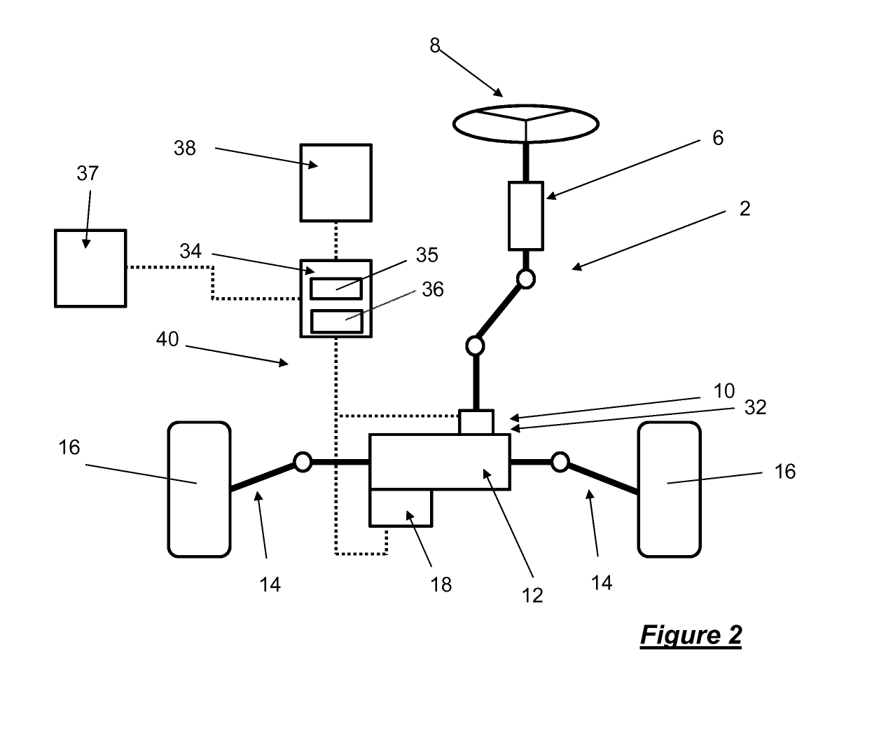

With reference to FIGS. 1 and 2, there is shown a steering system 2 of a vehicle 4. Although the following description is provided in the context of the particular vehicle illustrated in FIGS. 1 and 2, it will be appreciated that this vehicle is merely an example and that other vehicles may certainly be used instead. For instance, in various embodiments, the methods and systems described herein may be used with any type of vehicle having an automatic, manual, or continuously variable transmission, including traditional vehicles, hybrid electric vehicles (HEVs), extended-range electrical vehicles (EREVs), battery electric vehicles (BEVs), passenger cars, sports utility vehicles (SUVs), cross-over vehicles, and trucks, to cite a few possibilities. In any event, according to an illustrative embodiment, the steering system 2 comprises a rotatable steering column 6 coupled at a proximal end to a driver steering input device in the form of a steering wheel 8. At an opposed, distal end, the steering column 6 comprises a pinion 10.

In FIG. 1, the distal end of steering column 6 and distal components of steering system 2 linked thereto are not shown in the interest of clarity. Referring now therefore specifically to the illustrative embodiment illustrated in FIG. 2, a steering member in the form of a rack bar 12 is co-operable and mechanically coupled with steering column 6, and pinion 10 thereof, in particular, such that rotary motion of steering column 6 causes linear motion of rack bar 12, and linear motion of rack bar 12 causes rotary motion of steering column 6. Furthermore, in the illustrated embodiment, rack bar 12 is coupled via first and second tie rod assemblies 14 to first and second wheels 16, such that linear motion of rack bar 12 causes first and second wheels 16 to be steered. Wheels 16 may thus be steered by rotation of steering wheel 8, which leads to rotation of steering column 6, which in turn causes linear movement of rack bar 12 and steering of wheels 16.

In an embodiment, steering of wheels 16 is assisted by an actuator in the form of an electric steering assistance motor 18 coupled to, for example, rack bar 12. In such an embodiment, steering system 2 is thus an Electric Power Assisted Steering (EPAS or EPS) system, or vehicle 4 at includes an EPAS system that is used in conjunction with steering system 2.

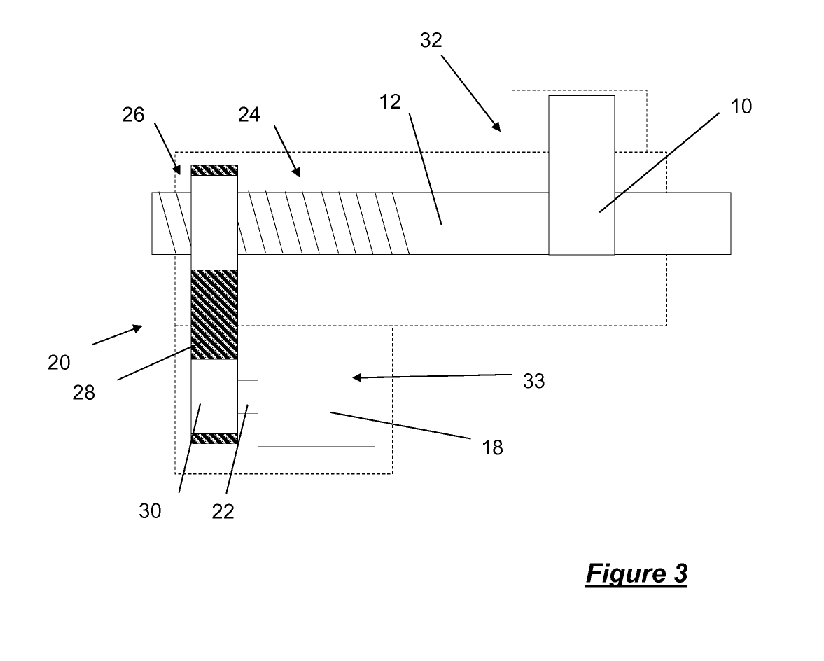

Referring now additionally to FIG. 3, in an illustrative embodiment, steering assistance motor 18 is coupled to rack bar 12 in a parallel-axis arrangement. In particular, rack bar 12 is linearly movable along a first axis, and electric motor 18 comprises a rotor rotatable about a second axis, the first and second axes being generally parallel. For purposes of this disclosure, “generally parallel” is intended to include instances wherein the first and second axes are exactly parallel, and those instances wherein the axes are not exactly parallel but are nonetheless suitably arranged such that rack bar 12 and motor 18 operate as intended (e.g., within an acceptable tolerance of the components). It will be appreciated, that while a parallel-axis arrangement of rack bar 12 and motor 18 has been described, the present invention is not intended to be limited to any particular arrangement(s) of motor 18 and rack bar 12, as any suitable arrangement may be used, including those in which the axes of the motor 18 and rack bar 12 may not be parallel.

Referring particularly to the embodiment depicted in FIG. 3, steering assistance motor 18 is coupled to rack bar 12 via a coupling 20 that translates rotary movement of a rotor 22 of motor 18 into linear force upon rack bar 12. In the illustrated embodiment, rack bar 12 comprises a screw thread 24 and a fixedly-positioned ball assembly 26. Ball assembly 26 is configured to be driven by motor 18 and is engaged with screw thread 24 of rack bar 12 such that it acts as a nut. Motor 18 is therefore able to impart linear force and movement to rack bar 12 by rotating ball assembly 26. In an embodiment, ball assembly 26 is driven by motor 18 via a toothed belt 28, and rotor 22 of motor 18 comprises a pinion 30 for engaging toothed belt 28.

Referring again to FIG. 1, steering assistance motor 18 assists in providing torque required to control the direction of steered wheels 16. One or more torque sensors 32 in the region of pinion 10 may be used to monitor, sense, detect, measure, or otherwise determine any steering torque that is indicative of a steering input provided by the driver through steering wheel 8. Torque sensor(s) 32 may comprise any suitable torque sensor known in the art that is capable of determining an amount of steering torque that is being applied in dependence on a driver steering input. Furthermore, motion of rack bar 12 is detected by a rotor position sensor 33 within motor 18. A steering control means 34 in the form an electronic controller (i.e., controller 34) receives information from, for example, sensors 32, 33 and calculates an amount of assistive torque to apply. Controller 34 also commands or controls motor 18 via, for example, a controller area network (CAN) bus, a system management bus (SMBus), a proprietary communication link, or using another suitable communication technique, to apply that assistive torque.

It is to be understood that electronic controller 34 described herein can comprise a control unit or computational device having one or more electronic processors (e.g., a microprocessor, a microcontroller, an application specific integrated circuit (ASIC), etc.). The system 2 may comprise a single control unit or electronic controller or alternatively different functions of the controller may be embodied in, or hosted in, different control units or controllers. As used herein, the term “control unit” will be understood to include both a single control unit or controller and a plurality of control units or controllers collectively operating to provide the required control functionality. A set of instructions could be provided which, when executed, cause said controller to implement the control techniques described herein (including some or all of the functionality or methodologies described herein). The set of instructions could be embedded in said one or more electronic processors. Alternatively, the set of instructions could be provided as software to be executed in said controller. A first controller may be implemented in software run on one or more processors. One or more other controllers may be implemented in software run on one or more processors, optionally the same one or more processors as the first controller. Other arrangements are also useful.

In an illustrative embodiment such as that shown in FIG. 2, controller 34 comprises an electronic processor 35 having one or more electrical inputs and one or more electrical outputs. Controller 34 further includes an electronic memory device 36 that is part of or electrically connected to the processor 35, and that is accessible by processor 35. In an embodiment, memory device 36 has instructions for software, firmware, programs, algorithms, scripts, applications, information etc. stored therein or thereon that may govern all or part of the methodologies described herein. Processor 35 may access memory device 36 and execute and/or use instructions/information stored therein or thereon to carry out or perform some or all of the functionality and methodologies describe herein. Alternatively, some or all of the aforementioned instructions/information may be embedded in a computer-readable storage medium (e.g. a non-transitory or non-transient storage medium) that may comprise any mechanism for storing information in a form readable by a machine or electronic processors/computational devices, including, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; or electrical or other types of medium for storing such information/instructions. Additionally, controller 34 may also be electronically connected to other components of system 2 or vehicle 4 via suitable communications (e.g. CAN bus, SMBus, a proprietary communication link, or through some other arrangement known in the art) and can interact with them when or as required.

It will be appreciated that steering system 2 or vehicle 4 (e.g., a system of vehicle 4 other than steering system 2) may include any number of different sensors, components, devices, modules, systems, etc., configured to monitor, sense, detect, measure, or otherwise determine a variety of parameters. For example, in addition to those described above (i.e., steering wheel torque sensor 32 and rotor position sensor 33), steering system 2 or vehicle 4 may include: steering angle sensor(s) for monitoring, sensing, detecting, measuring, or otherwise determining a steering angle imparted to steering column 6 or a rate of change of the steering angle imparted to steering column 6); steering column torque sensor(s) for monitoring, sensing, detecting, measuring, or otherwise determining steering torque imparted to steering column 6; vehicle speed sensor(s) for monitoring, sensing, detecting, measuring, or otherwise determining the speed of the vehicle 4; suspension articulation sensor(s) for monitoring, sensing, detecting, measuring, or otherwise determining suspension articulation; and/or proximity sensor(s) for monitoring, sensing, detecting, measuring, or otherwise determining proximity of the vehicle 4 to another one or more of a moving or stationary object, and which may include, for example, forward or rearward looking radar or LIDAR sensors, ultrasonic sensors or the like. In any event, sensors of system 2 or vehicle 4 may provide information that can be used by the methodology described herein, and may be embodied in hardware, software, firmware, or some combination thereof. The sensors may directly sense or measure the conditions or parameters for which they are provided, or they may indirectly evaluate such conditions/parameters based on information provided by other sensors, components, devices, modules, systems, etc. Further these sensors may be directly coupled to controller 34, indirectly coupled thereto via other electronic devices, vehicle communications bus, network, etc., or coupled in accordance with some other suitable arrangement known in the art.

In addition to being configured to provide assistive torque as described above, in at least some embodiments, motor 18 may also be controlled or commanded by controller 34 to generate oscillatory feedback that is provided or communicated to the driver of vehicle 4 via one or more components of steering system 2. In an illustrative embodiment, controller 34 is configured to receive a request to provide oscillatory feedback through steering system 2, and in dependence thereon, to send an oscillation command to motor 18 to impart an oscillating force to rack bar 12 or another component of steering system 2 operatively coupled to motor 18.

The request to provide oscillatory feedback may take a number of forms. In an illustrative embodiment, the request comprises an electrical signal representative of an actual command to provide oscillatory feedback received from a component or system of vehicle 4 that is configured to determine whether one or more defined conditions exist. In other words, when the component or system configured to determine whether one or more defined conditions exist determines that the defined condition(s) does in fact exist, it sends an electrical signal commanding the provision of oscillatory feedback to controller 34 via, for example, a CAN bus or using another suitable communication technique. In another illustrative embodiment, the request comprises an electrical signal indicative of the existence of one or more defined conditions received from a component or system of vehicle 4 configured to determine whether the one or more defined conditions exist. In other words, when the component or system configured to determine whether one or more defined conditions exist determines that the defined condition(s) does in fact exist, it sends an indicator or warning signal to controller 34 via, for example, a CAN bus or using another suitable communication technique, that simply informs controller 34 that the condition exists.

In yet another illustrative embodiment, controller 34 may be configured to determine whether one or more defined conditions exist. In such an embodiment, the request may comprise an electrical signal received from a sensor of vehicle 4 or another vehicle component either directly or indirectly via, for example, a CAN bus or using another suitable communication technique, that is representative of a value of a particular parameter that is indicative of the existence of one or more defined conditions. In such an embodiment, controller 34 is configured to interpret the received value and to determine that the defined condition(s) exist. Accordingly, it will be appreciated that the request to provide oscillatory feedback is not limited to any particular form or type of request.

As described above, in an embodiment, a request to provide oscillatory feedback is based on the existence of one or more defined conditions. The defined conditions may comprise any number of conditions. One such condition relates to the position of the vehicle in the lane in which it is travelling, and comprises detecting that the vehicle is departing (e.g., drifting) from the lane. Another condition relates to driver alertness, and comprises detecting that the driver is drowsy. Other examples of conditions may include, without limitation, the vehicle speed exceeding a particular threshold and a forward alert warning being triggered alerting the driver that the distance or time separation to a vehicle ahead has fallen below a particular threshold value. While several examples of possible conditions have been specifically identified, it will be appreciated that conditions in addition to or in lieu of those identified above may certainly be used for the purposes described herein, as the present invention is not intended to be limited to any particular condition(s).

As briefly described above, a determination as to whether one or more defined conditions exist may be made by any number of components or systems of vehicle 4. For example, one or more systems or components 37 of vehicle 4 other than steering system 2 may be configured to determine whether one or more defined conditions exist. These components or systems may be dedicated components or systems and/or may be shared systems or components configured to perform other functionality (e.g., an electronic vehicle control unit 38). In either instance, systems/component 37, 38 are further configured to provide a notification in one form or another to controller 34 when it is determined that the respective condition(s) exist. Additionally or alternatively, and as briefly described above, controller 34 may be configured to determine whether one or more defined conditions exist. In any instance, a determination as to whether one or more defined conditions exist may be based on information received from one or more systems or components of vehicle 4, including, for example, components of steering system 2, one or more of the vehicle sensors identified herein, and/or other vehicle components/systems, for example, electronic vehicle control unit 38. By way of illustration, an example of a lane departure sensor arrangement is described in WO2008091565 A1, the entire contents of which are incorporated herein by reference.

In an embodiment, the controller 34 is configured to periodically determine whether a command for oscillatory feedback is needed or is appropriate. Controller 34 may be configured with a routine for determining regularly, e.g. once per second, half second, etc., whether an oscillation command should be sent to motor 18. If appropriate, controller 34 may be further configured to distinguish between distinct variants of a particular defined condition (e.g., different lane departure warning states).

In any event, the oscillation may be imparted by alternation of the direction and/or changing, in particular a pulsed change to, the speed of motor 18. In an embodiment, there is minimal or no net movement of rack bar 12 as a result of the oscillation command applied to rack bar 12. In other words, rack bar 12 may return to its original position after the oscillation, subject to any other movement of rack bar 12, e.g., due to driver steering input and/or steering assistance.

The oscillation command sent by controller 34 includes instructions related to the properties of the oscillation to be imparted by motor 18, including, for example, one or more of timing, frequency and amplitude of the oscillation. The properties of the oscillation are consistent with providing desired oscillatory (e.g., haptic and audible) feedback, in particular structure borne noise or vibration. In an embodiment, an oscillation has a duration in the range of from 0.5 to 3 seconds, for example, in the range of from 1 to 2 seconds, and, in an embodiment, about 1.6 seconds. In an embodiment, the oscillation has a frequency in the range of from 15 to 35 Hz, for example, in the range of from 25 to 27 Hz, and, in an embodiment, about 26 Hz. In an embodiment, the oscillation provides a handled torque in the range of from 0.5 to 5 Nm, for example in the range of from 1 to 3 Nm in steering column 6, and, in an embodiment, about 2 Nm. In an embodiment, the maximum displacement of the steering member (e.g., rack bar 12) by the oscillation is in the range of from 0 to 0.5 mm, for example in the range of from 0 to 0.1 mm, and, in an embodiment, about 0.1 mm, and in another embodiment, about 0.09 mm. It will be appreciated, however, that the present invention is not limited to the property values identified above.

In an embodiment, controller 34 is configured for selecting the sent oscillation command from a plurality of oscillation commands. In this way steering system 2 is configured to offer a range of oscillatory feedback. A list of oscillation commands is stored and mapped against, for example, associated lane departure warnings (or types of warnings other than lane departure warnings, as the case may be) in a look-up table accessible by or within controller 34. Each one of the plurality of oscillation commands comprises instructions related to the properties of its associated oscillation. To enable distinct oscillatory feedback in dependence on distinct conditions, e.g., lane departure warnings, the plurality of oscillation commands comprises a plurality of oscillation commands with differing instructions related to one or more properties of their oscillations.

In an embodiment wherein rotatable steering column 6 is co-operable with rack bar 12, oscillation of rack bar 12 leads to oscillation of steering column 6, particularly rotary oscillation. In this manner steering system 2 provides for effective oscillatory (e.g., haptic) feedback. In particular, since oscillating force is applied relatively distally, i.e., to rack bar 12 rather than directly to steering column 6 or steering wheel 8, an advantageously realistic oscillatory feedback is achieved, closely simulating feedback received via wheels 16 of the vehicle when driving over, for example, a rumble strip.

In an embodiment, steering system 2 also provides for wider oscillatory feedback through the vehicle structure. In particular, rack bar 12 may be mounted such that the oscillating force can be perceived not only through steering column 6 and steering wheel 8, but also through other vehicle surfaces or structures 40. In an embodiment, rack bar 12 is coupled to steerable wheels 16 of vehicle 4 such that the oscillating force is transferred to vehicle structure 40 via the steering and/or suspension of the vehicle (not shown). This provides the advantage that oscillatory (e.g., haptic) feedback may still be noticeable even if a driver is not touching steering wheel 8.

In an embodiment, controller 34 may be configured for determining a combined actuation command based on the oscillation command and a desired steering assist torque. The controller may advantageously be configured for sending the combined actuation command (comprising the oscillation command and a steering assist torque command) to motor 18 for simultaneously applying assistive torque and imparting an oscillating force to rack bar 12, for example by motor 18 alone. In an embodiment, the oscillation command may be superimposed onto the steering assist torque command, thereby allowing controller 34 to continue to assist steering vehicle 4 at the same time as providing oscillatory feedback to the driver.

In view of the foregoing, it will be appreciated that steering system 2 thus illustrates and is configured to perform or carry out a method of providing oscillatory feedback through a steering system by imparting an oscillating force to a linearly movable steering member of the steering system, to which a driver steering input is coupled via a rotatable steering column of the steering system. And in an embodiment, the oscillating force that generates the feedback may be provided using an actuator that simultaneously also provides steering assistance to steering system 2.

It will be appreciated that many modifications can be made to steering system 2 without departing from the scope of the invention as defined in, for example, the appended claims. For example, controller 34 could be configured to command oscillatory feedback in additional or alternative defined conditions. A dedicated actuator could be employed for imparting oscillation to the steering member (e.g., rack bar 12) instead of steering assist motor 18, and/or a hydraulic actuator may be used instead of an electric actuator.

For economy, controller 34 performing the described oscillatory feedback functions in an embodiment also functions as a steering assistance controller (e.g., a controller of an EPAS system). Controller 34 could be further programmed to perform other known control functions within the vehicle, e.g., those of the electronic vehicle control unit 38. It will be appreciated that the electronic vehicle control unit 38 may, in addition to some or all of the functions described above, carry out one or more other control functions of vehicle 4 as known in the art. Alternatively, a dedicated controller not performing any other functions at all, or a controller of an entirely different system of vehicle 4 could be used for the oscillatory feedback system. Controller 34 may thus be implemented as a shared controller of vehicle 4 or as a dedicated controller.

In addition to the functionality described above relating to the provision of oscillatory feedback, controller 34 may also be configured to omit sending the oscillation command, and therefore, to inhibit the provision of oscillatory feedback. In an embodiment, this functionality may be in dependence on an override factor, for example, a sharp turn state. A sharp turn state may be determined when the value of an applied steering torque, which may be received from, for example, a vehicle component/system (e.g., electronic vehicle control unit 38 or one or more vehicle sensors) or from a sensor of steering system 2 (e.g., steering torque sensor 32), is above a predetermined threshold value.

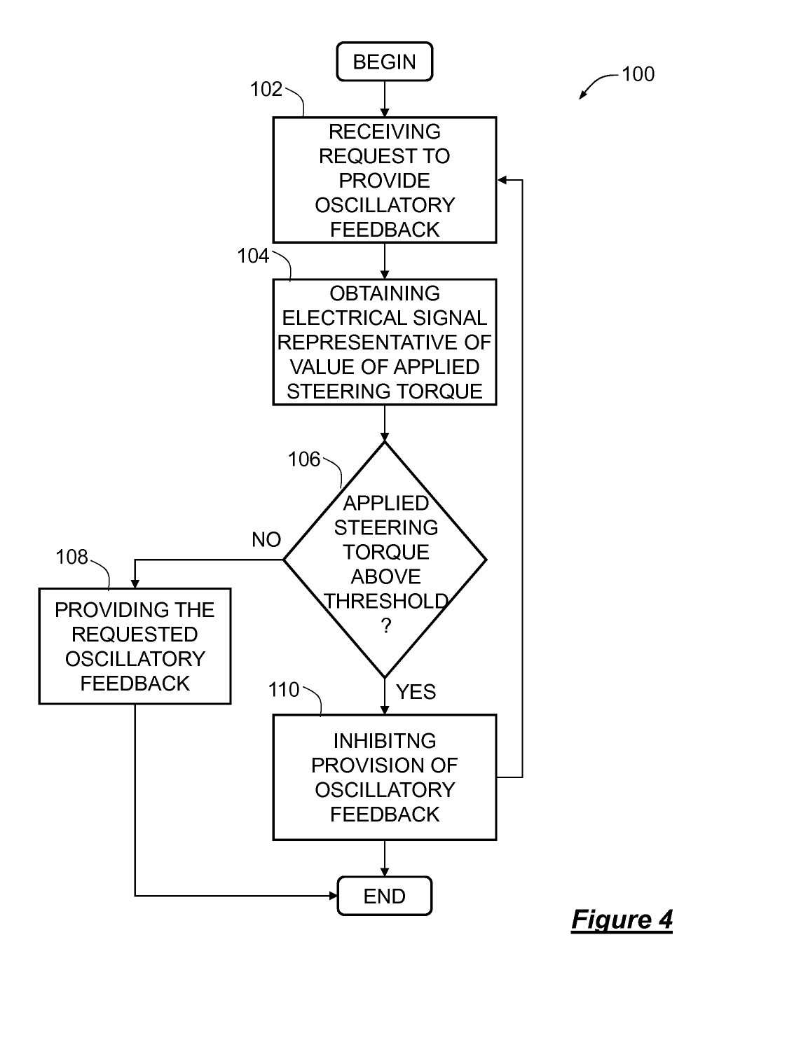

FIG. 4 illustrates an exemplary method 100 for controlling the provision oscillatory feedback through the steering system of a vehicle. It will be appreciated that while method 100 will be described in the context of vehicle 4 described above and illustrated in FIGS. 1-3, and steering system 2 and controller 34 thereof, in particular, application of the methodology is not meant to be limited solely to such an arrangement. Rather, method 100 may find application with any number of arrangements (i.e., the steps of method 100 may be performed by systems or components of vehicle 4 other than that or those described herein, or vehicle arrangements (e.g., steering systems, oscillatory feedback systems, etc.) other than that or those described above (e.g., those oscillatory feedback systems briefly described in the Background section above)). Additionally, it will be appreciated that unless otherwise noted, the performance of method 100 is not meant to be limited to any one particular order or sequence of steps or to any particular component(s) for performing the steps.

In the embodiment illustrated in FIG. 4, method 100 comprises a step 102 of receiving a request to provide oscillatory feedback through the steering system of the vehicle (e.g., steering system 2 of vehicle 4). A description of such a request including the different forms it may take and the different sources from which it may be received is set forth above and will not be repeated; rather, it is incorporated here by reference. In an embodiment, the request is received by controller 34 of steering system 2. More particularly, the request may be received at an electrical input of controller 34.

Method 100 further comprises a step 104 of obtaining an electrical signal representative of a value of an applied steering torque that indicates the presence of a driver steering input through, for example, a steering input device (e.g., steering wheel 8) of the vehicle. The electrical signal may be obtained in a number of ways. In an embodiment, steering torque sensor 32 senses or measures the amount of applied torque and an electrical signal representative of that sensed or measured value is communicated to controller 34 either directly from sensor 32 or indirectly via one or more components of vehicle 4 (e.g., a CAN bus, SMBus, proprietary communication link). In another embodiment, the value of the applied torque is determined by vehicle control unit 38 or another component of vehicle 4 other than steering system 2 or controller 34 thereof, which then, in turn, communicates an electrical signal representative of the applied torque value to controller 34. It will therefore be appreciated that the present invention is not intended to be limited to any particular way(s) in which an electrical signal representative of a value of an applied torque is obtained, as any number of suitable ways may be used. In an embodiment, the electrical signal representative of the applied torque value is obtained by controller 34 at an electrical input thereof.

Following step 104, method 100 includes a step 106 of comparing the obtained applied steering torque value to a predetermined threshold value. The threshold value may be stored in an electronic memory device of or accessible by controller 34 (e.g., electronic memory device 36) and in an embodiment, is a vehicle type- or platform-specific threshold value meaning that different vehicle types or platforms may use different threshold values. In an embodiment, the threshold value is a predetermined, empirically-derived value that is programmed into a suitable component of steering system 2 or vehicle 4 (e.g., electronic memory device 36 of controller 34) as part of the manufacturing process of vehicle 4 or steering system 2. In at least some embodiments the threshold value is nonadjustable; while in other embodiments the threshold value may be modified by, for example, a service technician or, in some implementations, the user of vehicle 4. In any event, in an embodiment, controller 34, and processor 35 thereof in particular, is configured to perform the comparison of step 106.

The particular step method 100 proceeds to following the comparison performed in step 106 is dependent upon the outcome of the comparison. As shown in FIG. 4, if the applied torque value is below (or, in an embodiment, meets or is below the threshold value), method 100 may move to a step 108 of providing the oscillatory feedback requested in step 102. Accordingly, controller 34 may control or command assistive torque motor 18 of steering system 2 to provide the requested feedback (e.g., may send an oscillation command to motor 18).

If, on the other hand, the applied torque value is above (or, in an embodiment, meets or is above) the threshold value, it can be determined that the driver of the vehicle is almost certainly controlling the vehicle, and method 100 may then proceed to a step 110 of inhibiting the provision of oscillatory feedback that would ordinarily be provided in dependence on the request received in step 102 (or commanding that such feedback be inhibited). In other words, if it is determined in step 106 that the applied torque is above the predetermined threshold, which may be indicative of a sharp turn state, controller 34 does not command or at least inhibits the application of an oscillation force by motor 18 of steering system 2, and therefore, does not command the provision of oscillatory feedback.

It will be appreciated in view of the above that at least one benefit or advantage of at least some embodiments or implementations of the present invention, among potentially others, is that in instances wherein oscillatory feedback would ordinarily be provided, but it is determined that the driver is clearly controlling the vehicle based on at least a particular amount of steering torque being applied, provision of the oscillatory feedback is inhibited so as to not distract or disturb the driver while the driver is controlling the vehicle.

It will be understood that the embodiments described above are given by way of example only and are not intended to limit the invention, the scope of which is defined in the appended claims. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater or different steps than that shown here. All such other embodiments, changes, and modifications are intended to come within the scope of the appended claims. Additionally, features, characteristics, or aspects described in conjunction with one embodiment are to be understood to be applicable to any other embodiment described herein unless incompatible therewith.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Further, the terms “comprise” and “contain” and variations thereof, for example “comprising” and “comprises”, mean “including but not limited to”, and are not intended to (and do not) exclude other possibilities not expressly provided for herein. Moreover the singular encompasses the plural unless the context otherwise requires: in particular, where the indefinite article is used, the specification is to be understood as contemplating plurality as well as singularity, unless the context requires otherwise. Other terms are to be construed using their broadest reasonable meaning unless they are used in a context that requires a different interpretation.

1. A method for controlling the provision of oscillatory feedback through a steering system of a vehicle, comprising:
receiving a request to provide oscillatory feedback through the steering system of the vehicle;
obtaining an electrical signal representative of a value of an applied steering torque that indicates the presence of a driver steering input;
comparing the value of the applied steering torque to a predetermined threshold value; and
when the applied steering torque value is above the predetermined threshold value, automatically inhibiting the provision of the oscillatory feedback.

2. The method of claim 1, wherein the applied steering torque is indicative of a steering torque applied by a user through a steering input device of the vehicle.

3. The method of claim 1, wherein the obtaining step comprises obtaining the electrical signal from a steering torque sensor of the vehicle.

4. The method of claim 1, wherein the predetermined threshold value is a vehicle-specific threshold value.

5. The method of claim 1, wherein the oscillatory feedback comprises haptic feedback.

6. The method of claim 1, wherein the receiving step comprises receiving an indication that a defined condition exists.

7. The method of claim 1, wherein when the applied steering torque value is below the predetermined threshold, the method comprises commanding the provision of the requested oscillatory feedback through the steering system, and further wherein the commanding step is performed by an electronic controller of an electric power assisted steering (EPAS) system.

8. A non-transitory, computer-readable storage medium storing instructions thereon that when executed by one or more electronic processors causes the one or more electronic processors to carry out the method of claim 1.

9. A system for controlling the provision of oscillatory feedback through a steering system of a vehicle, comprising:
an electronic processor having one or more electrical inputs for receiving a request to provide oscillatory feedback and for obtaining an electrical signal representative of a value of an applied steering torque that indicates the presence of a driver steering input; and
an electronic memory device electrically coupled to the electronic processor and having instructions stored therein,
wherein the electronic processor is configured to access the memory device and execute the instructions stored therein such that it is configured to:
receive a request to provide oscillatory feedback;
obtain a value of an applied steering torque represented by an electrical signal received at the one or more electrical inputs of the electronic processor;
compare the value of the applied steering torque to a predetermined threshold value; and
when the applied steering torque value is above the predetermined threshold value, automatically inhibiting the provision of oscillatory feedback.

10. The system of claim 9, wherein the applied steering torque is indicative of a steering torque applied by a user through a steering input device of the vehicle.

11. The system of claim 9, wherein the request to provide oscillatory feedback comprises an indicator that a defined condition exists.

12. The system of claim 9, comprising a steering torque sensor configured to provide the electrical signal representative of the applied steering torque value.

13. The system of claim 9, wherein the predetermined threshold value is a vehicle-specific threshold value.

14. The system of claim 9, wherein the oscillatory feedback comprises haptic feedback.

15. The system of claim 9, wherein when the applied steering torque value is below the predetermined threshold value, the electronic processor is configured to command the provision of the requested oscillatory feedback, and further wherein the electronic processor comprises an electronic processor of an electric power assisted steering (EPAS) system controller.

16. A vehicle comprising the system of claim 9.

17. A vehicle steering system comprising the system of claim 9.

18. An electric power assisted steering system for a vehicle comprising the system of claim 9.

19. An electronic controller for a vehicle having a storage medium associated therewith storing instructions therein that when executed by the controller causes the controlling of the provision of oscillatory feedback through a steering system of the vehicle in accordance with the method of:
receiving a request to provide oscillatory feedback through the steering system of the vehicle;
obtaining an electrical signal representative of a value of an applied steering torque that indicates the presence of a driver steering input;
comparing the value of the applied steering torque to a predetermined threshold value; and
when the applied steering torque value is above the predetermined threshold value, automatically inhibiting the provision of the oscillatory feedback.

20. The electronic controller of claim 19, wherein when the applied steering torque value is below the predetermined threshold value, the controller causes the provision of the requested oscillatory feedback, and further wherein the controller comprises a controller of an electric power assisted steering (EPAS) system.

21. A vehicle comprising the electronic controller of claim 19.

22. A vehicle steering system comprising the electronic controller of claim 19.

23. An electric power assisted steering system for a vehicle comprising the electronic controller of claim 19.
